(19) United States
(12) Patent Application Publication
(10) Pub. No.: US 2014/0025775 A1
(43) Pub. Date: Jan. 23, 2014

(54) CONTENT DELIVERY SYSTEM AND METHOD BASED ON INFORMATION-CENTRIC NETWORKING

(71) Applicant: Electronics and Telecommunications Research Institute, Daejeon (KR)

(72) Inventors: Byung-Joon Lee, Daejeon (KR); Seung-Hyun Yoon, Daejeon (KR)

(21) Appl. No.: 13/944,687

(22) Filed: Jul. 17, 2013

(30) Foreign Application Priority Data
Jul. 18, 2012 (KR) 10-2012-0078301

(51) Int. Cl. H04L 29/08

(52) U.S. Cl. CPC H04L 67/10
USPC 709/217

(57) ABSTRACT

A content delivery system and method based on information-centric networking (ICN) are provided. A node closest to a content provider (CP) may be designated as a node to process a content publication request of a specific CP. A content publication load is distributed and processed by a plurality of nodes, so that the network cost and load related to content publication may be reduced.

### CROSS-REFERENCE TO RELATED APPLICATION

This application claims the benefit under 35 U.S.C. §119(a) of a Korean Patent Application No. 10-2012-0078301, filed on Jul. 18, 2012, in the Korean Intellectual Property Office, the entire disclosure of which is incorporated herein by reference for all purposes.

### BACKGROUND

1. Field

The following description relates to content delivery technology, and more particularly, to a content delivery system and method based on information-centric networking (ICN).

2. Description of the Related Art

Reverse proxy technology has been proposed in U.S. Pat. No. 7,650,392 (Jan. 19, 2010) and the like. A reverse proxy is a proxy server which functions to fetch content absent within a content delivery network (CDN) surrogate from a content provider (CP).

When the reverse proxy technology is used, there is convenience in that content may be acquired through the reverse proxy even when the CDN surrogate does not recognize a CP origin server from which the content absent within a storage device (or server) managed by the CDN surrogate should be fetched.

However, there is usually one reverse proxy on a normal CDN network. Accordingly, the burden of fetching content and transferring the fetched content to the CDN surrogate concentrates on one reverse proxy. Also, there may be a problem in that a communication path between the reverse proxy and the CP origin server is lengthened and the performance of service is deteriorated according to a location of the CP origin server.

Thus, the inventors of the present invention propose a method capable of solving a problem in an existing reverse proxy in a CDN using ICN technology.

### SUMMARY

The following description relates to an ICN-based content delivery system and method in which a node closest to a specific CP may be designated as a node to process a content publication request of the CP and a content publication load is distributed and processed by a plurality of nodes.

In one general aspect, there is provided a content delivery system based on ICN, including a content publication manager, wherein the content publication manager includes: a content registration request receiving unit configured to receive content registration request information from a CP origin server; a content identifier (ID) generating unit configured to generate a content ID corresponding to a content registration request when the content registration request receiving unit receives the content registration request information from the CP origin server; a content ID mapping unit configured to map an address at which corresponding content is located and metadata of the content with the content ID generated by the content ID generating unit and store a mapping result; and a content publication requesting unit configured to select an ICN node closest to the CP origin server requesting content registration and transmit content publication request information corresponding to the content ID to the selected ICN node.

In another general aspect, there is provided a content delivery system based on ICN, including an ICN node, wherein the ICN node includes: a content publication request receiving unit configured to receive content publication request information including a content ID, an address at which corresponding content is located, and a file name from a content publication manager; a reverse proxy information processing unit configured to generate reverse proxy information including the content ID, the address at which the corresponding content is located, and the file name when the content publication request receiving unit receives the content publication request information, and register the reverse proxy information in a reverse proxy record table; and a notification unit configured to notify an entire ICN network that the content corresponding to the content ID may be acquired through the ICN node itself when the reverse proxy information processing unit registers the reverse proxy information.

In still another general aspect, there is provided a content delivery method based on ICN, including: receiving, by a content publication manager, content registration request information including an address at which content is located and metadata from a CP origin server; generating, by the content publication manager, a content ID corresponding to a content registration request when the content registration request information is received from the CP origin server; mapping, by the content publication manager, the address at which the corresponding content is located and the metadata of the content with the generated content ID, and storing a mapping result; and selecting, by the content publication manager, an ICN node closest to the CP origin server requesting the content registration and transmitting content publication request information including the content ID, the address at which the corresponding content is located, and a file name to the selected ICN node.

In an additional aspect, the content delivery method further includes: receiving, by the ICN node, the content publication request information from the content publication manager; generating, by the ICN node, reverse proxy information including the content ID, the address at which the corresponding content is located, and the file name upon receiving the content publication request information from the content publication manager, and registering the reverse proxy information in a reverse proxy record table; and notifying, by the ICN node, an entire ICN network that the content corresponding to the content ID may be acquired through the ICN node itself upon registering the reverse proxy information.

In an additional aspect, the content delivery method further includes: receiving, by the content publication manager, a content request of a user from a service router; identifying, by the content publication manager, a content ID corresponding to requested content upon receiving the content request of the user from the service router; selecting, by the content publication manager, the ICN node which provides the content corresponding to the identified content ID; and transmitting, by the content publication manager, to the content request of the user through the selected ICN node.

In an additional aspect, the content delivery method further includes providing, by the ICN node, the content corresponding to the content ID requested by the user to a user terminal of the user when the content request of the user is detoured and received from the content publication manager.

According to the present invention, a node closest to a specific CP is designated as a node to process a content publication request of the CP, so that network cost related to content publication may be reduced in the ICN node.

According to the present invention, a content publication load is distributed and processed by a plurality of nodes, so that a network load related to content publication may be reduced and CDN scalability may be improved.

Other features and aspects will be apparent from the following detailed description, the drawings, and the claims.

### BRIEF DESCRIPTION OF THE DRAWINGS

FIG. 1 is a block diagram illustrating an example of a network configuration of an ICN-based content delivery system.

FIG. 2 is a block diagram illustrating an example of a configuration of a content publication manager of the ICN-based content delivery system.

FIG. 3 is a block diagram illustrating an example of a configuration of an ICN node of the ICN-based content delivery system.

FIG. 4 is a diagram illustrating an example of reverse proxy information generated by the ICN node of the ICN-based content delivery system.

FIGS. 5 to 7 are flowcharts illustrating an example of an ICN-based content delivery method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In addition, the following terms are terms that are defined in consideration of functions in the present invention and may vary according to a user's and operator's intentions or practices. Thus, their definitions should be based on contents throughout the present specification.

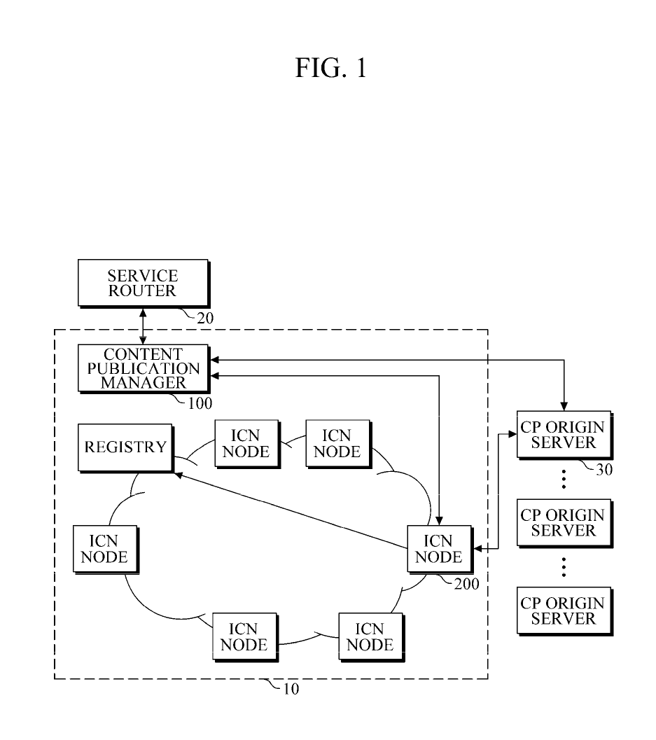

FIG. 1 is a block diagram illustrating an example of a network configuration of an ICN-based content delivery system. As illustrated in FIG. 1, a CDN includes an ICN network 10, a service router 20, and a plurality of CP origin servers 30.

The ICN network 10 includes a content publication manager 100 and a plurality of ICN nodes 200. The service router 20 transfers a content request (hypertext transfer protocol (HTTP) request) from a user terminal (not illustrated) to an ICN node closest to the user terminal. At this time, the ICN node functions as a surrogate of the CDN. The CP origin server 30 is possessed by a CP, and is a place in which content is initially stored by the CP.

According to an example of the present invention, ICN nodes 200 within the ICN network 10 perform communication based on a content ID instead of an Internet protocol (IP) address. The ID-based communication can be implemented by a specific ICN node referred to as a registry responsible for a function of mapping a content ID to an address at which content is located, and implemented by extending an existing IP routing protocol such as open shortest path first (OSPF) which is a hierarchical dynamic routing protocol for use in IP networking.

Although an ICN network in which the ID-based communication is performed based on the registry is assumed in FIG. 1, contents of the present invention are also directly applicable to an ICN network in which another type of ID-based communication is performed. In case of the ICN network based on an IP routing protocol such as OSPF, it is only necessary to propagate content location information to a network through an OSPF message instead of registering the content location information in the registry. Accordingly, when the ICN node 200 notifies the entire ICN network 10 that content corresponding to a content ID may be acquired through the ICN node itself, it is only necessary to distinguish and process each case.

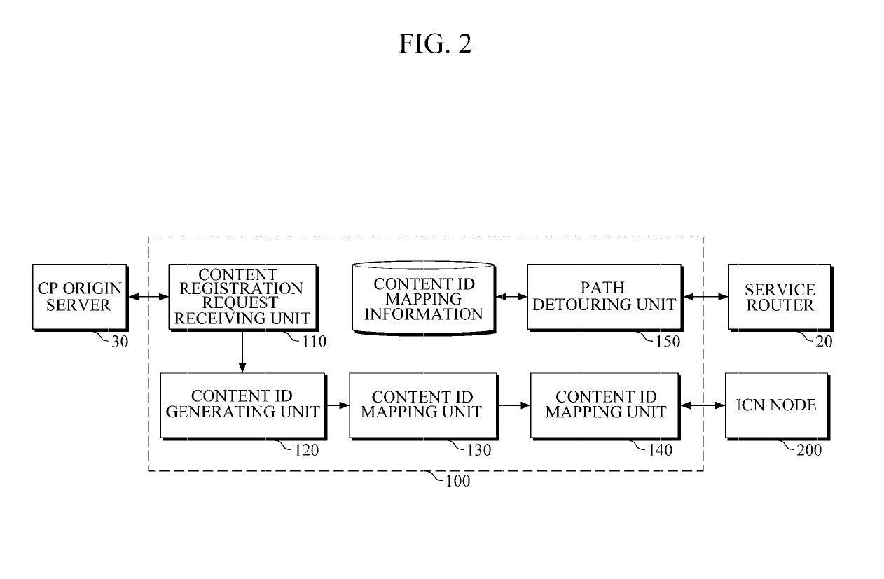

FIG. 2 is a block diagram illustrating an example of a configuration of the content publication manager of the ICN-based content delivery system. As illustrated in FIG. 2, the content publication manager 100 according to this embodiment may include a content registration request receiving unit 110, a content ID generating unit 120, a content ID mapping unit 130, and a content publication requesting unit 140.

The content registration request receiving unit 110 receives content registration request information from the CP origin server 30. At this time, the content registration request information may include an address at which content is located and metadata. The metadata may include a content name, a content description, and information about a CP for providing the content.

When the content registration request receiving unit 110 receives the content registration request information from the CP origin server 30, the content ID generating unit 120 generates a content ID corresponding to a content registration request. At this time, the content ID may be generated from a series of numerical characters or letters or a combination thereof as unique information for identifying each piece of content.

The content ID mapping unit 130 maps an address at which the corresponding content is located and metadata of the content with the content ID generated by the content ID generating unit 120, and stores a mapping result. At this time, the content ID mapping unit 130 may acquire the address at which the content is located and the metadata mapped to the content ID from the content registration request information.

The content publication requesting unit 140 selects an ICN node 200 closest to the CP origin server 30 requesting content registration, and transmits the content publication request information corresponding to the content ID to the selected ICN node 200. At this time, the content publication request information may include the content ID, the address at which the corresponding content is located, and a file name.

The ICN node 200 closest to the CP origin server 30 requesting the content registration may be found by referring to path setup information about a path to be set up when a CDN or ICN network is configured. Because network path setup is not directly related to the present invention and is able to be implemented by various well-known technologies in the related art, its detailed description is omitted.

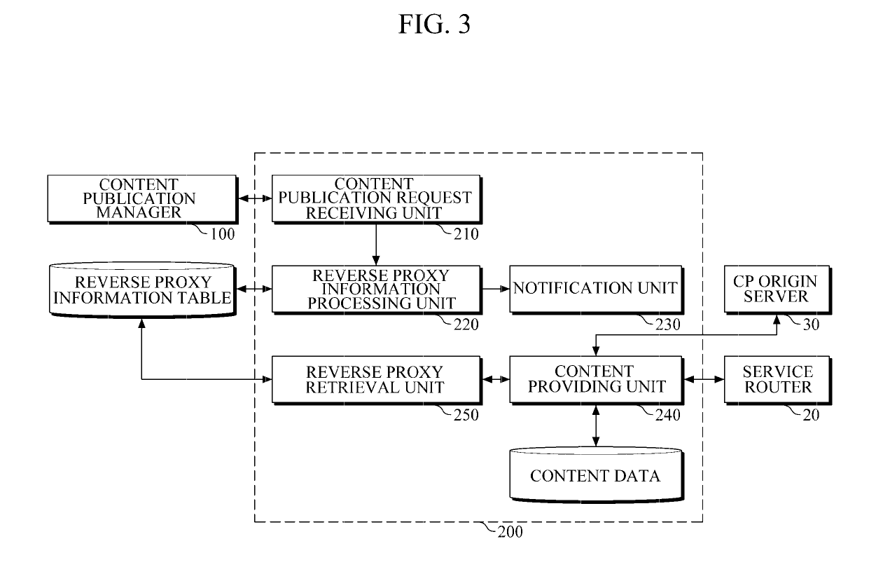

The ICN node 200 receiving the content publication request information transmitted by the content publication requesting unit 140 performs a function of performing a reverse proxy process, registering reverse proxy information, and notifying the entire ICN network that content corresponding to a content ID may be acquired through the ICN node 200 itself. This function will be described in detail later with reference to FIG. 3.

On the other hand, according to an additional aspect of the present invention, the content publication manager 100 may further include a path detouring unit 150. When a content request of a user is received from the service router 20, the path detouring unit 150 identifies a content ID corresponding to the requested content, selects an ICN node from which the content corresponding to the identified content ID is provided and transmits the content request of the user through the selected ICN node

At this time, the content publication manager 100 may find the ICN node based on information indicating that the ICN node 200 has notified the entire ICN network that content corresponding to a specific content ID may be acquired through the ICN node 200 itself. A process in which the ICN node 200 notifies the entire ICN network that content corresponding to a specific content ID may be acquired through its own node will be described in detail later.

Accordingly, the content publication manager 100 is implemented as described above, so that a node closest to a specific CP may be designated as a node to process a content publication request of the CP and network cost related to content publication may be reduced. A content publication load is distributed and processed by a plurality of nodes, so that a network load related to content publication may be reduced and CDN scalability may be improved.

FIG. 3 is a block diagram illustrating an example of a configuration of the ICN node of the ICN-based content delivery system. As illustrated in FIG. 3, the ICN node 200 according to this embodiment may include a content publication request receiving unit 210, a reverse proxy information processing unit 220, and a notification unit 230.

The content publication request receiving unit 210 receives content publication request information including a content ID, an address at which corresponding content is located, and a file name from the content publication manager 100.

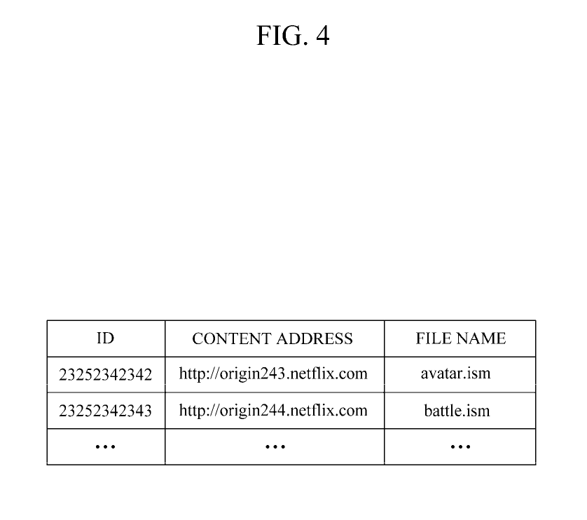

When the content publication request receiving unit 210 receives the content publication request information, the reverse proxy information processing unit 220 generates reverse proxy information including the content ID, the address at which the corresponding content is located, and the file name and registers the reverse proxy information in a reverse proxy record table as illustrated in FIG. 4.

FIG. 4 is a diagram illustrating an example of reverse proxy information generated by the ICN node of the ICN-based content delivery system. The reverse proxy information may be stored in a database (DB) of a specific ICN node or a separate server in the form of the reverse proxy record table.

When the reverse proxy information processing unit 220 registers the reverse proxy information, the notification unit 230 notifies the entire ICN network 10 that content corresponding to a content ID may be acquired through the ICN node 200 itself.

Thus, the content publication manager 100 and the ICN nodes 200 within the ICN network 10 may find an ICN node from which the content corresponding to the specific content ID may be acquired.

On the other hand, according to an additional aspect of the present invention, the ICN node 200 may further include a content providing unit 240. When a content request of the user is detoured and received from the content publication manager 100, the content providing unit 240 provides a user terminal (not illustrated) with the content corresponding to the content ID requested by the user.

When the user requests specific content through the user terminal, the service router 20 transfers the content request of the user to the content publication manager 100. Then, the content publication manager 100 identifies a content ID corresponding to the requested content, selects an ICN node which provides the content corresponding to the identified content ID, and makes a detour to the selected ICN node.

At this time, the content publication manager 100 may find the ICN node from which the content corresponding to the identified content ID is provided based on information from the ICN node 200 notifying the entire ICN network that content corresponding to a specific content ID may be acquired through the ICN node itself using the notification unit 230.

The ICN node 200 receiving the content request of the user through the detoured path provides the user terminal of the user with the content corresponding to the content ID requested by the user using the content providing unit 240.

For this, each ICN node 200 may pre-receive and store content corresponding to a specific content ID, which has been reported to the entire ICN network through the notification unit 230 of each ICN node 200, from the CP original server 30, or may receive and store the content from the CP origin server 30 when the content request has been received from the user terminal.

Meanwhile, according to an additional aspect of the present invention, the ICN node 200 may further include a reverse proxy retrieval unit 250. When the content corresponding to the content ID requested by the user is not held in the ICN node, the reverse proxy retrieval unit 250 retrieves and acquires the address at which the content corresponding to the content ID is located from the reverse proxy record table.

Then, the content providing unit 240 receives and stores the content corresponding to the content ID from the address at which the content retrieved by the reverse proxy retrieval unit 250 is located, and provides the user terminal with the received content corresponding to the content ID.

Accordingly, by implementing the ICN node 200 as described above, a content publication load is distributed and processed by a plurality of nodes. Therefore, a network load related to content publication may be reduced and CDN scalability may be improved.

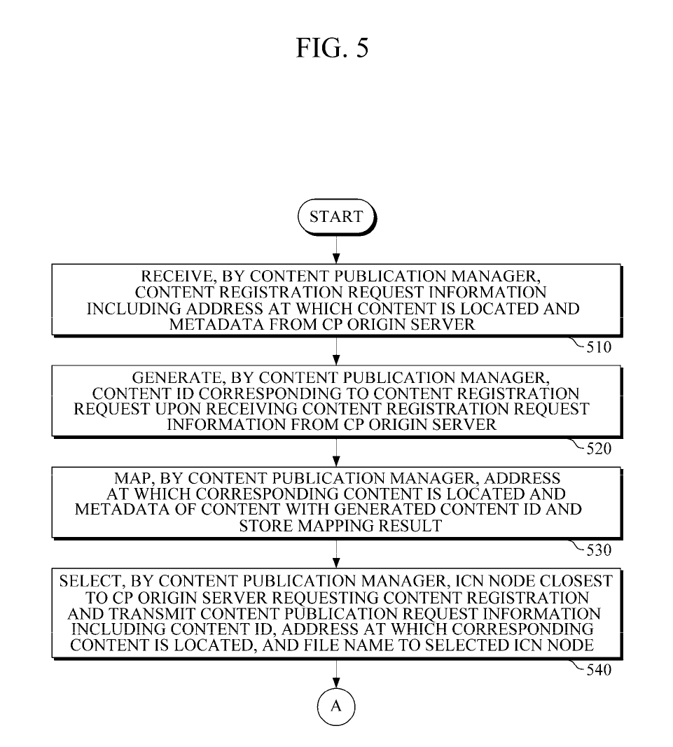

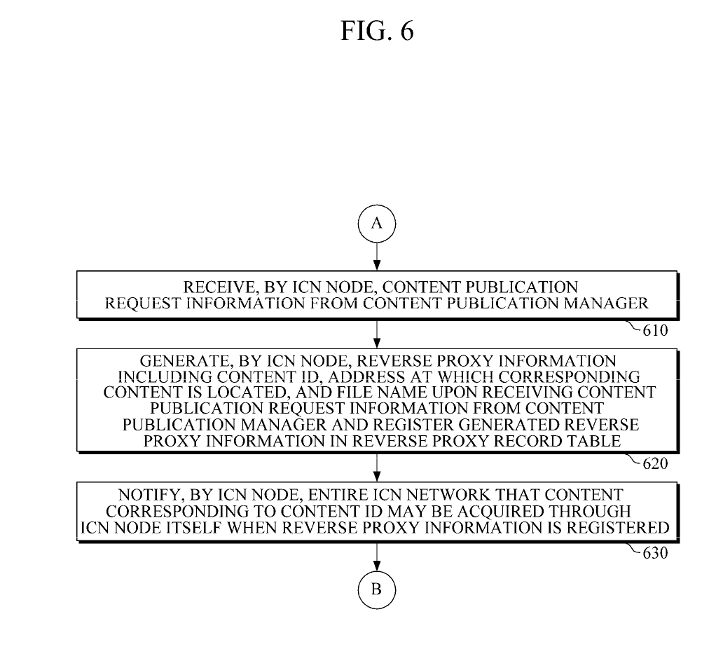

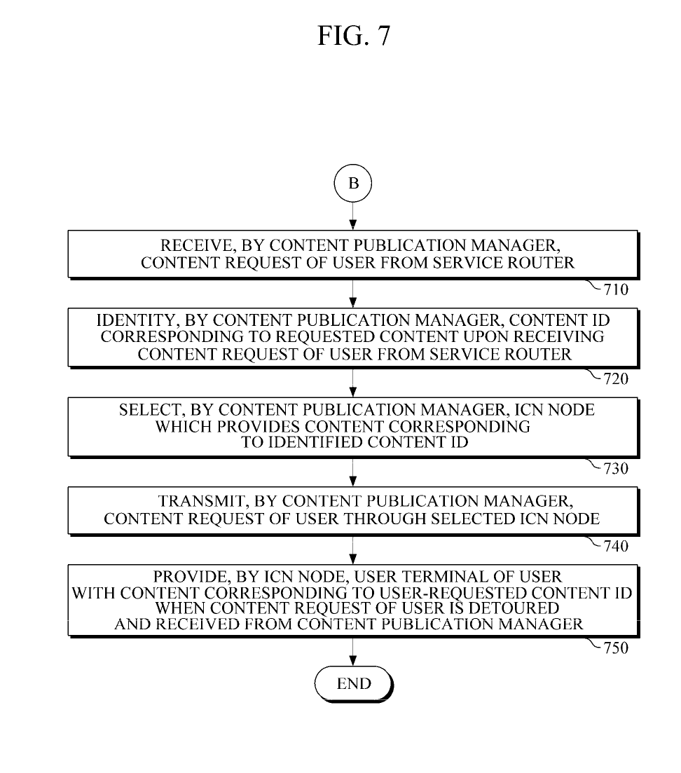

An ICN-based content delivery operation by the ICN-based content delivery system as described above will be described with reference to FIGS. 5 to 7. FIGS. 5 to 7 are flowcharts illustrating an example of the ICN-based content delivery method.

In the ICN-based content delivery method, first, the content publication manager 100 receives content registration request information including an address at which content is located and metadata from the CP origin server 30 in an operation 510.

Then, in an operation 520, the content publication manager 100 generates a content ID corresponding to a content registration request upon receiving the content registration request information from the CP origin server 30.

Then, in an operation 530, the content publication manager 100 maps the address at which the corresponding content is located and the metadata of the content with the generated content ID and stores a mapping result.

Then, in an operation 540, the content publication manager 100 selects an ICN node 200 closest to the CP origin server 30 requesting the content registration, and transmits content publication request information including the content ID, the address at which the corresponding content is located, and a file name to the selected ICN node 200.

Thus, the content publication manager 100 may designate an ICN node closest to the CP origin server as an ICN node to process a content publication request of a specific CP, so that network cost related to content publication may be reduced. A content publication load is distributed and processed by a plurality of nodes, so that a network load related to content publication may be reduced and CDN scalability may be improved.

Meanwhile, according to an additional aspect of the present invention, the ICN node 200 receives the content publication request information from the content publication manager 100 in an operation 610 in the ICN-based content delivery method.

Then, upon receiving the content publication request information from the content publication manager 100, the ICN node 200 generates reverse proxy information including the content ID, the address at which the corresponding content is located, and the file name and registers the reverse proxy information in a reverse proxy record table in an operation 620.

Then, in an operation 630, the ICN node 200 notifies the entire ICN network that the content corresponding to the content ID may be acquired through the ICN node 200 itself when the reverse proxy information is registered.

Accordingly, a content publication load is distributed and processed by a plurality of nodes 200, so that a network load related to content publication may be reduced and CDN scalability may be improved.

Meanwhile, according to an additional aspect of the present invention, the content publication manager 100 receives a content request of a user from the service router 20 in an operation 710 in the ICN-based content delivery method.

Then, in an operation 720, the content publication manager 100 identifies a content ID corresponding to requested content upon receiving the content request of the user from the service router 20.

Then, in an operation 730, the content publication manager 100 selects an ICN node which provides the content corresponding to the identified content ID.

Then, in an operation 740, the content publication manager 100 transmits the content request of the user through the selected ICN node 200.

Then, when the content request of the user is detoured and received from the content publication manager 100, the ICN node 200 provides a user terminal (not illustrated) with the content corresponding to the content ID requested by the user in an operation 750.

At this time, when the content corresponding to the content ID requested by the user is not held in the ICN node 200, the ICN node 200 retrieves and acquires the address at which the content corresponding to the content ID is located from the reverse proxy record table.

Then, the ICN node 200 receives and stores the content corresponding to the content ID from the address at which the retrieved content is located, and provides the user terminal with the received content corresponding to the content ID.

According to the example of the present invention, a node closest to the CP is designated as a node to process a content publication request of a specific CP, so that network cost related to content publication may be reduced.

According to the example of the present invention, a content publication load is distributed and processed by a plurality of nodes, so that a network load related to content publication may be reduced and CDN scalability may be improved. The object of the present invention described above may be accomplished.

The present invention can be implemented as computer readable codes in a computer readable record medium. The computer readable record medium includes all types of record media in which computer readable data is stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A content delivery system based on information-centric networking (ICN), comprising a content publication manager, wherein the content publication manager comprises:
a content registration request receiving unit configured to receive content registration request information from a content provider (CP) origin server;
a content identifier (ID) generating unit configured to generate a content ID corresponding to a content registration request when the content registration request receiving unit receives the content registration request information from the CP origin server;
a content ID mapping unit configured to map an address at which corresponding content is located and metadata of the content with the content ID generated by the content ID generating unit and store a mapping result; and
a content publication requesting unit configured to select an ICN node closest to the CP origin server requesting content registration and transmit content publication request information corresponding to the content ID to the selected ICN node.

2. The content delivery system of claim 1, wherein the content registration request information comprises the address at which the content is located and the metadata.

3. The content delivery system of claim 2, wherein the metadata comprises a content name, a content description, and CP information for providing the content.

4. The content delivery system of claim 2, wherein the content ID mapping unit acquires the address at which the content is located and the metadata mapped to the content ID from the content registration request information.

5. The content delivery system of claim 1, wherein the content publication request information comprises the content ID, the address at which the corresponding content is located, and a file name.

6. The content delivery system of claim 1, wherein the content publication manager further comprises a path detouring unit configured to identify a content ID corresponding to requested content upon receiving a content request of a user from a service router, select an ICN node that provides content corresponding to the identified content ID, and transmit the content request of the user through the selected ICN node.

7. A content delivery system based on ICN, comprising an ICN node, wherein the ICN node comprises:
a content publication request receiving unit configured to receive content publication request information comprising a content ID, an address at which corresponding content is located, and a file name from a content publication manager;
a reverse proxy information processing unit configured to generate reverse proxy information comprising the content ID, the address at which the corresponding content is located, and the file name when the content publication request receiving unit receives the content publication request information, and register the reverse proxy information in a reverse proxy record table; and
a notification unit configured to notify an entire ICN network that the content corresponding to the content ID may be acquired through the ICN node itself when the reverse proxy information processing unit registers the reverse proxy information.

8. The content delivery system of claim 7, wherein the ICN node further comprises a content providing unit configured to provide content corresponding to a content ID requested by a user to a user terminal of the user when the content request of the user is detoured and received from the content publication manager.

9. The content delivery system of claim 8, wherein the ICN node further comprises a reverse proxy retrieval unit configured to retrieve and acquire an address at which the content corresponding to the content ID is located from a reverse proxy record table when the content corresponding to the content ID requested by the user is not held in the ICN node.

10. The content delivery system of claim 9, wherein the content providing unit receives and stores the content corresponding to the content ID from the address at which the content retrieved by the reverse proxy retrieval unit is located, and provides the user terminal with the content corresponding to the received content ID.

11. A content delivery method based on ICN, comprising:
receiving, by a content publication manager, content registration request information comprising an address at which content is located and metadata from a CP origin server;
generating, by the content publication manager, a content ID corresponding to a content registration request when the content registration request information is received from the CP origin server;
mapping, by the content publication manager, the address at which the corresponding content is located and the metadata of the content with the generated content ID, and storing a mapping result; and
selecting, by the content publication manager, an ICN node closest to the CP origin server requesting the content registration and transmitting content publication request information comprising the content ID, the address at which the corresponding content is located, and a file name to the selected ICN node.

12. The content delivery method of claim 11, further comprising:
receiving, by the ICN node, the content publication request information from the content publication manager;
generating, by the ICN node, reverse proxy information comprising the content ID, the address at which the corresponding content is located, and the file name upon receiving the content publication request information from the content publication manager, and registering the reverse proxy information in a reverse proxy record table; and
notifying, by the ICN node, an entire ICN network that the content corresponding to the content ID may be acquired through the ICN node upon registering the reverse proxy information.

13. The content delivery method of claim 12, further comprising:
receiving, by the content publication manager, a content request of a user from a service router;
identifying, by the content publication manager, a content ID corresponding to requested content upon receiving the content request of the user from the service router;
selecting, by the content publication manager, the ICN node which provides the content corresponding to the identified content ID; and
transmitting, by the content publication manager the content request of the user through the selected ICN node.

14. The content delivery method of claim 13, further comprising providing, by the ICN node, the content corresponding to the content ID requested by the user to a user terminal of the user when the content request of the user is detoured and received from the content publication manager.

15. The content delivery method of claim 14, wherein the providing comprises retrieving and acquiring an address at which the content corresponding to the content ID is located from a reverse proxy record table when the content corresponding to the content ID requested by the user is not held in the ICN node.

16. The content delivery method of claim 15, wherein the providing comprises receiving and storing the content corresponding to the content ID from the address at which the content retrieved by the reverse proxy retrieval unit is located, and providing the user terminal with the content corresponding to the received content ID.
